(19) United States
(12) Patent Application Publication
(10) Pub. No.: US 2010/0211453 A1
(43) Pub. Date: Aug. 19, 2010

(54) METHOD AND APPARATUS FOR BUSINESS INFO PROVIDER-BASED ADVERTISING IN A LOCAL SEARCH MARKET

(76) Inventor: Evan S. Huang, Cupertino, CA (US)

Correspondence Address: Invent Capture, LLC, 3319 Foxtail Terrace, Fremont, CA, 94536, US

(21) Appl. No.: 12/667,524

(22) PCT Filed: Jul. 22, 2008
(86) PCT No.: PCT/US08/08890

§ 371 Date: Dec. 31, 2009

Related U.S. Application Data
(60) Provisional application No. 60/962,356, filed on Jul. 26, 2007.

(51) Int. Cl. G06Q 30/00; G06Q 10/00; G06F 17/30; G06F 15/16

(52) U.S. Cl. 705/14.39; 705/14.43; 705/14.54; 705/14.69; 707/769; 709/203; 707/E17.014

(57) ABSTRACT

An online local search system and method utilizes local business info providers to enter and update business information related to local businesses. The online local search system and method uses a territorial listing concept with an optional reservation stage, an editing stage, and a pending stage to reduce overlapping listings and promote robust update of business information. The online local search system and method also uses a territorial advertising concept, which allows a business info provider with more business listing entries to capture a larger portion of pay-per-user-interest (e.g. pay-per-click, pay-per-impression, pay-per-action, and etc.) profits based on in-category or out-category advertising on the online local search system.

### BACKGROUND OF THE INVENTION

The present invention generally relates to online local search industry. More specifically, the invention relates to a method and apparatus for business info provider-based advertising in a local search market over a computer network, such as the Internet.

Local search is a segment of online search marketplace where users attempt to find desired information about products, services or businesses which meet the users' thematic and/or geographic searching criteria. Local search provides a user-directed advertising venue that offers fairly precise targeting capabilities at low costs per lead. Many local businesses today which traditionally relied on print media are now experimenting with online advertising, especially in spatially-targeted search, in pursuit of achieving optimal advertising effects even with limited advertising budgets.

A key profit model for a local search Internet portal relies on a robust network traffic based on a large number of users who generate a high network access volume to the local search portal. In many cases, a local search portal makes profit by providing advertising opportunities to corporate or individual advertisement clients on the local search portal. A local search portal exhibiting a higher network traffic provides a more attractive consumer base to launch advertising campaigns for the corporate or individual advertisement clients than another local search portal with a lower network traffic. The higher network traffic often provides more pricing and bargaining power to a local search portal for its advertising-hosting fee structure.

In the Internet industry today, local versions of global-scale Internet search and portal providers such as Yahoo, Google, MSN, and AOL attract a majority of the local search traffic. These global-scale Internet search and portal providers typically license data from national directories of business listings. Many of these directory providers create their data primarily by recompiling paper-published Yellow Pages directories. The time delay between the paper-published Yellow Pages directories and real-time changes in local business directories create significant inaccuracies in online business listings. Furthermore, limited information from paper-published directories with only address and telephone number might not serve the needs of local search users who prefer more detailed information such as hours of service and range of services provided. Accordingly, there is a need for local online search providers to develop more effective methods for updating, verifying and enhancing the content of listings.

A typical advertising goal for a local business is to bring maximum amount of customer traffic in its store within a given amount of advertising budget. One effective strategy to achieve this goal is making an advertised local business to stay even in the minds of potential customers who may not be immediately looking for products or services from the advertised local business.

Existing online advertisement buying methods, such as keyword auctions for the global-scale Internet search engine providers, may not fit the advertising goal of many local businesses. Local business owners may not be familiar with the concept of keyword auctions or may not find keyword auctions sufficiently effective to justify advertising investment. This is especially true in small businesses, in which a typical owner tends to be reactive rather than proactive for any business-related advertising strategies. Furthermore, the existing methods of online advertisement buying process are often cumbersome and time-consuming to be appealing to the local business owners. For local business owners, salespeople from the Yellow Pages or local newspapers have been more convenient and convincing methods of placing advertisement for their businesses. Therefore, it may be advantageous to leverage local advertising salespeople even for online advertising, especially if the advertising salespeople are business info providers who create personal-level relationships and bond with local business owners. Accordingly, a method and apparatus for business info provider-based online advertising for online local search market may be highly beneficial for local businesses and potential customers.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

An apparatus for an online local search system communicating with online local search system users and business info providers is disclosed. The apparatus comprises the online local search system configured to provide one or more databases for local business listing information, advertisement information, and membership information, wherein the one or more databases are accessible by the online local search system users and the business info providers over a web interface, a first software interface configured to reserve a plurality of business listings by the business info providers, wherein the first software interface is configured to reserve one or more business listings for a particular business info provider to grant an exclusive or non-exclusive right for data field entry for a certain number of days reserved by the online local search system, and a second software interface configured to process a business listing fee and/or an advertising-hosting fee submitted by the particular business info provider to the online local search system after the data field entry is complete for the one or more business listings reserved by the particular business info provider, wherein the business listing fee and/or the advertising-hosting fee are configured to be adjusted by discount incentive variables, including a total number of listings and/or a total number of advertisements posted to the online local search system by the particular business info provider.

Furthermore, a method for using an online local search system for business info provider-based listing for local businesses based on a territorial listing concept is disclosed. The method comprises finding a local business to gather information for data entry into the online local search system, finding more information about the local business by visiting the local business or having a discussion with an owner of the local business or a marketing representative associated with the local business, submitting the information for data entry related to the local business into the online local search system, waiting for a reviewer associated with the online local search system to complete an approval process for the data entry related to the local business, and receiving a listing fee discount and/or an advertisement-hosting fee discount from the online local search system if the data entry is approved by the reviewer and a certain criteria is met for fee discount.

In addition, a method for conducting business between a business info provider and an online local search system is disclosed. The method comprises logging into an online local search system as the business info provider, optionally making a reservation for potentially entering or updating information related to a particular local business in the online local search system for a certain number of days, speaking and/or meeting with an owner of the particular local business or a marketing representative associated with the particular local business and completing a listing deal and/or an advertising deal based on mutually-agreed terms, logging into the online local search system and completing information entry related to the particular local business which may have been optionally reserved by the business info provider, waiting for an approval of the information entry from the online local search system, and logging into the online local search system after the approval to pay a listing fee and/or an advertising-hosting fee related to the particular local business.

### BRIEF DESCRIPTION OF DRAWINGS

FIG. 1 shows an apparatus for an online local search system communicating with users and business info providers through the Internet in accordance with an embodiment of the invention.

FIG. 2 shows a screenshot of a software interface for posting business related information by a business info provider to a business listing database of an online local search system in accordance with an embodiment of the invention.

FIG. 3 shows a screenshot of a software interface for posting an advertisement for a business from a business info provider to an advertisement information database of an online local search system in accordance with an embodiment of the invention.

FIG. 4 shows a screenshot of a business info provider's information from a membership information database of an online local search system in accordance with an embodiment of the invention.

FIG. 5 shows a screenshot of a software interface for conducting a geographic search and a thematic search by a user accessing an online local search system in accordance with an embodiment of the invention.

FIG. 6 shows a screenshot of searching results from an online local search system in accordance with an embodiment of the invention.

FIG. 7 shows a screenshot of requested information by a user for a particular business from an online local search system in accordance with an embodiment of the invention.

FIG. 8 shows a flowchart for using an online local search system for business info provider-based listing for local businesses based on a territorial listing concept in accordance with an embodiment of the invention.

FIG. 9 shows a flowchart for a first method of conducting business between a business info provider and an online local search system in accordance with an embodiment of the invention.

FIG. 10 shows a flowchart for a second method of conducting business between a business info provider and an online local search system in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of procedures, logic blocks, processing, and other symbolic representations that directly or indirectly resemble a method or an apparatus for business info provider-based listing and advertising of local businesses using an online local search system. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

In general, embodiments of the invention relate to an online local business listing, search, and advertising industry. In particular, the invention relates to a method and apparatus for independent business info provider-based business listing and advertising with an online local search system. Furthermore, the invention also relates to a method of conducting business for profit between a business info provider for local business listing and advertising and an online local search system.

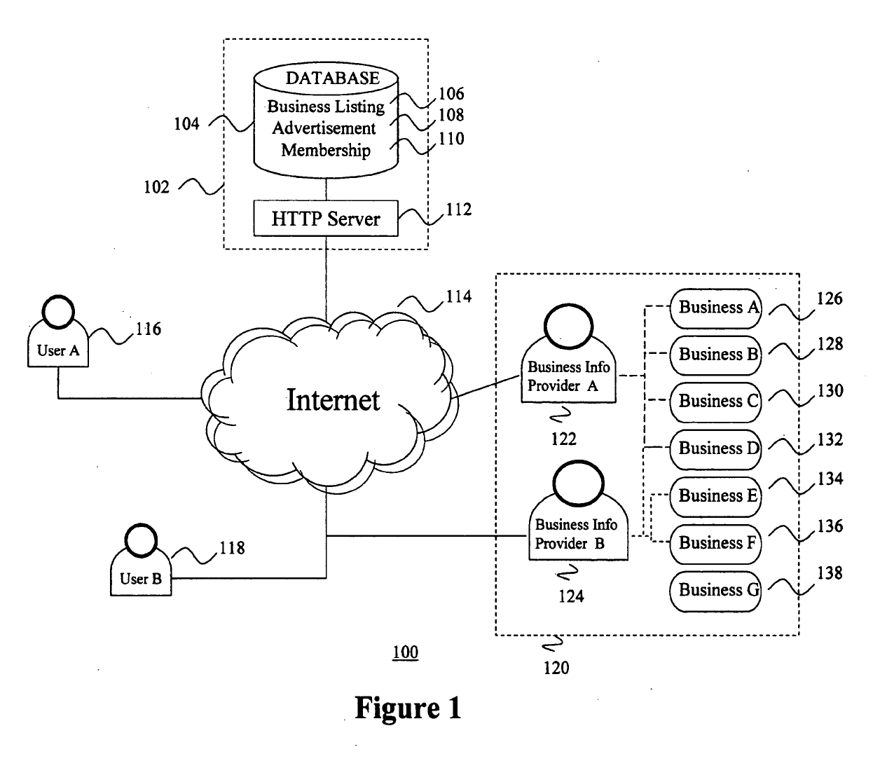

FIG. 1 shows an apparatus (100) for an online local search system (102) communicating with online local search system users (116, 118) and business info providers (122, 124) through the Internet (114) in accordance with an embodiment of the invention. In a preferred embodiment of the invention, the business info providers (122, 124) act as freelance salespeople who gather local business information in a particular geographical boundary to list local businesses to the online local search system. A first profit model for the business info providers (122, 124) is paying a fixed fee to the online local search system (102) to list each gathered business listing in the online local search system (102) and make money by soliciting advertisement payments from at least some local businesses which are listed by a particular business info provider. In the first profit model, the particular business info provider typically spends some portions of the advertisement payments from local businesses to pay advertising hosting fees to the online local search system (102) and keeps the difference between the advertisement payments from local businesses and advertising hosting fees as a business info provider's profit.

This is a novel and somewhat counter-intuitive method of business conduct between a business info provider and the provider of online local search system, because the provider is getting paid by business info providers instead of paying each business info provider for a new entry of a local business listing. Existing local business listing providers such as Google have attempted to give business info providers a financial incentive to list and update local business information by paying a monetary compensation for some non-overlapping business listing information. However, the local business listing provider-to-business info Provider payment model championed by Google largely failed to gain much traction, in part due to a small compensation structure and likelihood of excessive number of overlapping local business listings.

A key motivation for the novel, business info provider-to-local search system provider payment model instead of local search system provider-to-business info provider payment model comes from a passive and reactive tendency of many local businesses to under-utilize local online business listing services. Unlike midsize to large corporations, small local business owners often overlook online business listing services and fail to maximize their advertising and information-publishing opportunities.

In the first profit model for business info providers described previously, the present invention embodies a novel business model which nurtures professional-level business info providers who are incentivized by a substantial difference in advertising payment by a local business owner who wants to list and advertise in the online local search system (102) and an advertising hosting fee charged by the online local search system (102). In a preferred embodiment of the invention, a business info provider (122 or 124) provides a turn-key solution for listing and advertising updates and management for each local business under his or her “listing contract”, thereby justifying a business info provider's profit by providing a simplified but effective business advertising strategy for a particular local business.

Continuing with FIG. 1, a second profit model for the business info providers (122, 124) is making a pay-per-user-interest (e.g. pay-per-click, pay-per-impression, pay-per-action, and etc.) profit on an advertisement displayed by the online local search system (102) which may be in the same thematic category as the business info providers' gathered business listings (i.e. defined herein as “in-category” advertisement) or outside the thematic category as the business info providers' gathered business listings (i.e. defined herein as “out-category” advertisement). For example, in FIG. 1, a Business Info Provider A (122) listed Business A (126), Business B (128), Business C (130), Business D (132). These four business listings (126, 128, 130, 132) form an in-category advertising “territory” for the Business Info Provider A, in which thematic categories (e.g. automotive, computer & electronics, entertainment & arts, food & dining, and etc.) represented by the four business listings enable exposure of paying advertisement banners to the Business Info Provider A (122). For example, if a software interface from the online local search system (102) shows one or more business listings from the Business Info Provider A (122) to a user, the software interface may also show in-category advertisements related to the those businesses. Continuing with this example, if the user clicks on one of the in-category advertisement, the Business Info Provider A (122) may be entitled to a pay-per-user-interest (e.g. pay-per-click, pay-per-impression, pay-per-action, and etc.) profit paid by an advertiser, a business owner, an outside entity, or the online local search system (102) itself. Similarly, if the software interface from the online local search system (102) shows some things related to the Business Info Provider A (122) or his/her listings, then a user's click on one of the out-category advertisements on the same screen displayed by the software interface may entitle the Business Info Provider A (122) to a pay-per-user-interest (e.g. pay-per-click, pay-per-impression, pay-per-action, and etc.) profit paid by an advertiser, a business owner, an outside entity, or the online local search system (102) itself.

The second profit model for the business info providers (122, 124) described above incentivizes the business info providers (122, 124) to expand their in-category advertising territories by gathering more business listings for the online local search system (102) because a business info provider who has a larger in-category advertising territory receives a correspondingly larger in-category pay-per-user-interest (e.g. pay-per-click, pay-per-impression, pay-per-action, and etc.) profit benefit from the online local search system (102).

Continuing with FIG. 1, in one embodiment of the invention, the online local search system (102) contains a HTTP server (112) and a system database (104), where the system database (104) further contains several sets of information including a business listing information database (106), an advertisement information database (108), and a membership information database (110).

In a preferred embodiment of the invention (i.e. “best mode” as envisioned by the inventor), an online local search system can be configured as a distributed system, with one or more computer servers and databases to contain a variety of information including the business listing information database (106), advertisement information database (108), and membership information database (110). In this embodiment of the invention, a portal server can be configured to gather information from the distributed system and communicate with online local search system users (116, 118) and business info providers (122, 124) through the Internet (114).

A major profit model for an online local search system (102) provider is derived from a plurality of business-related advertisements (108) and business listing fees from business listings (120) which garner premium and intrinsic advertising values from a robust Internet traffic between the online local search system users (116, 118) and the online local search system (102). One reason for a user (116 or 118) to visit a website operatively connected to the online local search system (102) is to search and find desired information for a particular business from the business listing information database (106) in the system database (104). Therefore, a frequently-updated, robust local business listing content is a key factor in nurturing a heavily-visited and successful online local search website. The two profit models described for business info providers in accordance with the present invention give significant financial incentives to business info providers for robust business listing and updates of business listing contents. Existing solutions prior to the conception of the present invention primarily derived business listing data from national directories of business listings which are not frequently updated, thereby often carrying outdated or obsolete business information.

Continuing with FIG. 1, a user (116 or 118) accessing a website operatively connected to the online local search system (102) may have some motivation to look for sales information and attractive service or merchandise deals in the advertisement information database (108). Because the current online advertisement buying process is too detailed and time consuming to be appealing to many local business owners, the two business info provider profit models conceptualized in the present invention incentivize business info providers to frequently update the online local search system (102) by soliciting advertising fees from local businesses and/or expanding in-category advertising territories. The frequent local business listing updates from the business info providers in turn attract robust network traffic from the online local search system users (116, 118), hence contributing to an overall success of the business info provider-based advertising in a local search market as embodied by the present invention.

Continuing with FIG. 1, in one embodiment of the invention, there is a geographic regional boundary (120) with local business info providers (122, 124) and a list of local businesses (126, 128, 130, 132, 134, 136 and 138). The business info provider A (122) has posted business listing information for Business A (126), Business B (128), Business C (130), and Business D (132) and the business info provider B (124) has posted the listing information for Business D (132), Business E (134), and Business F (136) to the online local search system (102). In this particular example, Business D (132) has been listed by both business info providers A and B (122, 124). In some cases, it is desirable to set a rule of listing engagement and priorities to reward a business info provider who has brought a particular business listing information (e.g. Business D (132)) before other business info providers. One example of reward is higher exposure to in-category and/or out-category advertising pay-per-user-interest (e.g. pay-per-click, pay-per-impression, pay-per-action, and etc.) profit to a particular business info provider if the particular business info provider submitted more first-time business listings than others who later submitted information for the same business listings. For the purpose of the present invention, the rule of listing engagement and priorities among business info providers of a particular geographical region is called a “territorial listing concept”.

One example of the territorial listing concept is using a three-stage listing procedure. In one embodiment of the invention, a first stage is a “reservation” stage in which a business info provider (122 or 124) reserves a right to post information about a particular local business in 10 days. The reservation stage helps the business info provider (122 or 124) to reduce duplicated entry of business listings because other business info providers (122, 124, and etc.) can also see the particular local business as a reserved listing. A second stage of the three-stage listing procedure is an “editing” stage in which the business info provider (122 or 124) who reserved the particular local business enters or edits information related to the particular local business, typically after a personal visit and discussion with an owner of the particular local business. The last stage of the three-stage listing procedure is a “pending” stage in which an online local search system (102) provider reviews the entered information for formalities, accuracies, and duplicated entry priorities to business info providers. In a preferred embodiment of the invention, a business info provider can still enter information related to an existing business listed (i.e. overlapped listing), but does not receive as much financial incentives (e.g. listing fee discounts, advertising-hosting discounts, advertising pay-per-user-interest (e.g. pay-per-click, pay-per-impression, pay-per-action, and etc.) profit exposure) from the online local search system (102) provider.

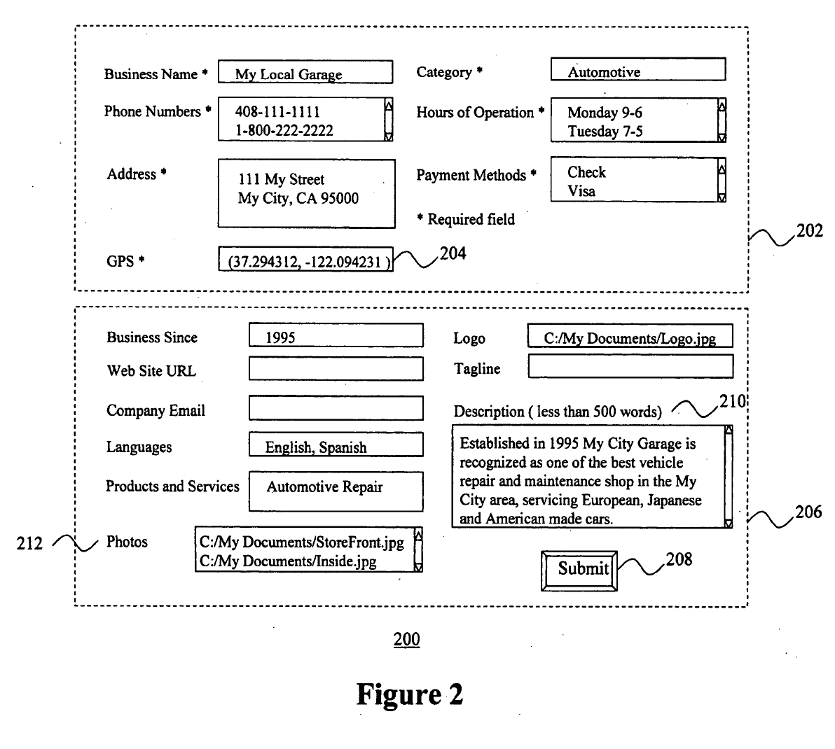

FIG. 2 shows a screenshot of a software interface (200) for posting business related information by a business info provider (122 or 124) to a business listing information database (106) of an online local search system (102) from FIG. 1 in accordance with an embodiment of the invention. In this software interface (200), a set of required information data fields (202) and a set of optional information data fields (206) are submitted to the online local search system (102) by pressing a “submit” button (208). In one embodiment of the invention, the set of required information date fields (202) includes a business name for a particular business, a category for the particular business, one or more phone numbers related to the particular business, an address of the particular business, and a GPS coordinate (204) of the particular business.

In one embodiment of the invention, the GPS coordinate (204) information is useful for pinpointing the location of a particular local business. The GPS coordinate (204) may be manually adjusted by the business info provider (122 or 124). For example, the business info provider may utilize an online map interface to enter an accurate GPS coordinate (204) of a particular business, sometimes even to pinpoint the particular business in a shopping mall or a crowded strip mall to provide the accurate GPS coordinate (204) beyond what a typical commercial navigation system provides to a consumer. The GPS coordinate (204) may be downloaded to a user's navigation system or a hand-held device for a convenient directional guidance to a listed business's location. Both the set of required information data fields (202) and the set of optional information data fields (206) are merely illustrative in FIG. 2 and other fields can be added or substituted in either sets based on a data entry requirement envisioned by an online local search system provider.

In one embodiment of the invention, the set of optional information data fields (206) contains a description field section (210) and a photo attachment section (212) among other data fields. The description field section (210) is configured to enter a brief description of a particular business symbolized by the set of required information data fields (202). The photo attachment section (212) is configured to upload a picture file (e.g. a picture file in JPG, BMP, and other formats) related to the particular business.

In one embodiment of the invention, the set of required information data fields (202) for the software interface (200) as shown in FIG. 2 is a minimum amount of information a business info provider is required to provide to the online local search system (102) of FIG. 1 for a successful submission of a business listing. In one embodiment of the invention, the successful submission of the business listing or an attempt to submit the business listing requires the business info provider to submit a business listing fee. For example, the business listing fee for submitting information to the online local search system (102) by the business info provider may be $10 per month or 25 cents per submission.

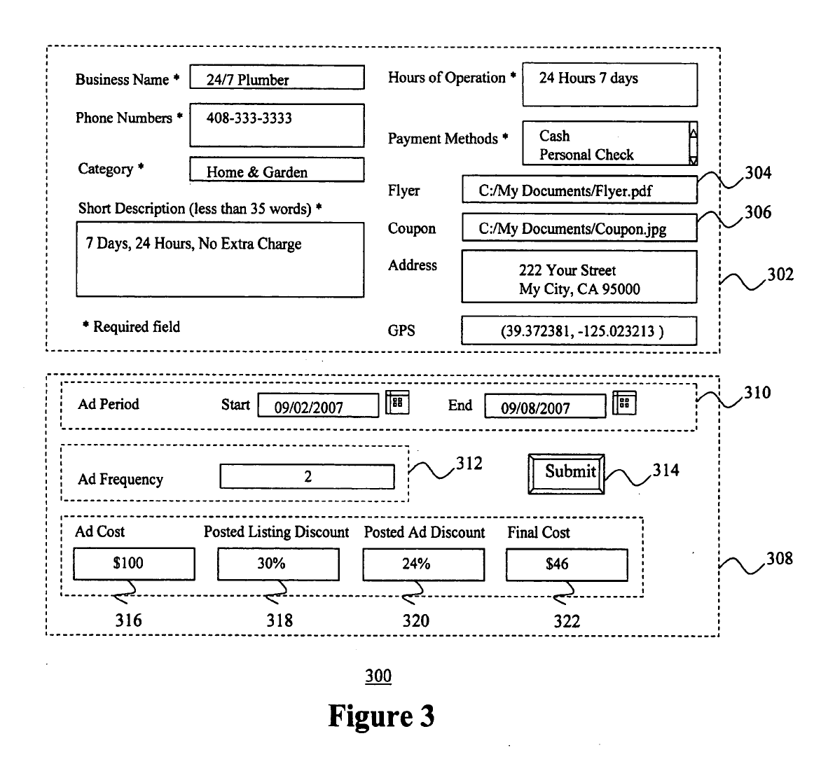

FIG. 3 shows a screenshot of a software interface (300) for posting an advertisement for a business (126, 128, 130, 132, 134, 136 or 138) from a business info provider (122 or 124) to an advertisement information database (108) of an online local search system (102) of FIG. 1 in accordance with an embodiment of the invention. In this software interface (300), a set of advertisement-related information (302) and a set of billing-related information (308) are submitted to the online local search system (102) by pressing a “submit” button (314). In one embodiment of the invention, the set of billing-related information (308) is for an advertising-hosting fee (322) to the online local search system (102), which may be paid separately or jointly with the business listing fee previously described for FIG. 2.

In one situation embodied by the present invention, a registered local business info provider sells an online advertisement deal to a local business which is also listed in the online local search system (102) by the same business info provider. In one embodiment of the invention, the advertising-hosting cost (316) depends on advertisement-related variables such as a flyer (304), a coupon (306), a length of an advertisement period (310), and an advertisement frequency (312). The final advertising-hosting fee (322) to the registered business info provider (122 or 124) may also depend on a posted listing discount (318) and a posted advertisement discount (320). In one embodiment of the invention, a scripting program may be embedded in the software interface (300) which utilizes certain information about a registered business info provider (122 or 124) in a membership information database (110) from FIG. 1 to adjust advertising costs based on a multiple number of variables. A difference between an advertisement payment from a particular local business and the final advertising-hosting fee (322) is typically a business info provider's profit from the particular local business.

In a preferred embodiment of the invention, the business info provider can provide a turn-key solution for business listing and advertising for the particular local business, thereby justifying his or her profit from the advertisement payment from the particular local business. Alternatively, instead of selling advertisement directly to the particular local business, the business info provider can attract a marketing representative for the particular local business to handle an advertisement campaign for the particular local business and optionally receive a referral/sales commission from the marketing representative. The business info provider can also make profit from his/her expanding exposure to in-category and out-category pay-per-user-interest (e.g. pay-per-click, pay-per-impression, pay-per-action, and etc.) advertising territories as the number of business listings submitted by the business info provider grows. On the other hand, the online local search system provider derives profit from a business listing fee (e.g. as described for FIG. 2) and/or the final advertising-hosting fee (322) paid by each registered business info provider (e.g. as described for FIG. 3).

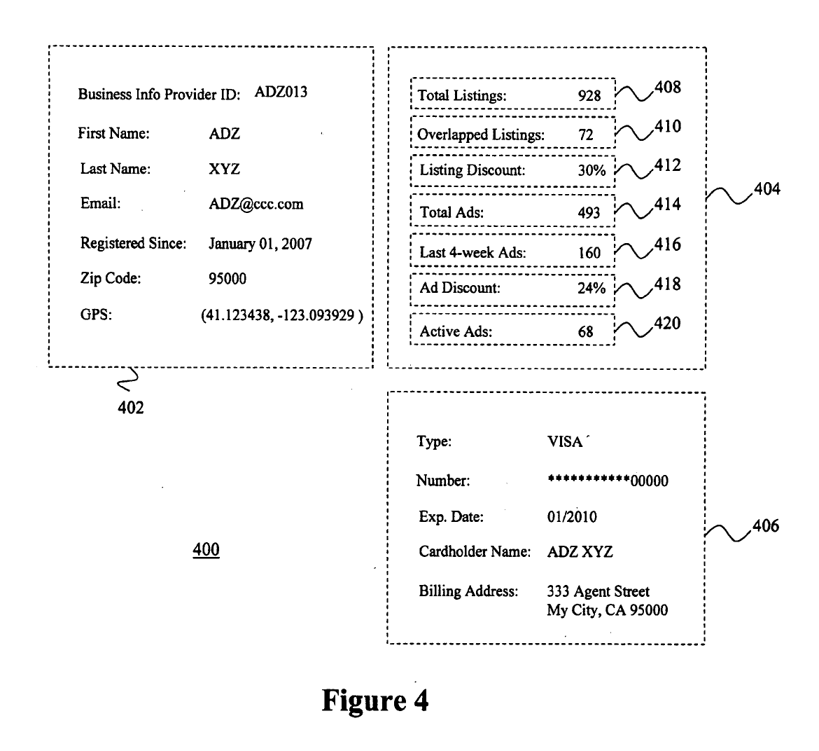

FIG. 4 shows a screenshot (400) of a business info provider's information from a membership information database (110) of an online local search system (102) of FIG. 1 in accordance with an embodiment of the invention. In this embodiment, the membership information database (110) contains a set of basic information (402), a set of posted information (404), and a set of billing information (406). In one embodiment of the invention, the set of billing information (406) is to charge a business info provider with the final advertising-hosting fee (322) when an advertisement is submitted to the online local search system (102).

In one embodiment of the invention, the set of posted information (404) contains a total number of business listings (408) which is the total number of business information (e.g. from the software interface (200)) submitted to the online local search system (102). In case of a particular example illustrated by FIG. 4, an overlapped business listings (410) represent a total number of submitted business information that has been previously submitted by other business info providers. Since photos, taglines, or descriptions in the set of optional information data fields (206) can vary from one business info provider to another, it may be beneficial to allow a multiple number of business info providers to overlap describing the same business listing.

Furthermore, if there is a major change in a particular local business, the major change is going to be reflected in the set of required information data fields (202). In one embodiment of the invention, a verified submission of the major change in the particular local business is not going to be treated as an overlapped listing, and a previous business listing for the particular local business gets removed from another business info provider's list of submitted businesses. An example of an overlapped business listing submission is Business D (132) which is submitted by both the business info provider A (122) and the business info provider B (124) in FIG. 1.

Continuing with FIG. 4, a business listing discount (412) is for the purpose of encouraging business info providers to post business information. In one embodiment of the invention, this discount can be based on the total number of business listings (408) and the total number of overlapped business listings (410). In one embodiment of the invention, the listing discount (412) is a fixed discount. For example, the listing discount of 30% in the business listing discount (412) is reached after a certain number of non-overlapped businesses (e.g. 400 non-overlapped businesses) are posted. In another embodiment, the business listing discount (412) is an incremental discount. For example, the incremental discount can start from a 1.5% discount to regular listing fees for a certain number of initial business listings, going up to a maximum ceiling discount of 30% to regular listing fees. In another embodiment of the invention, a basic discount (e.g. 15%) kicks in as a listing discount (412) when a certain number of non-overlapped businesses are reached by a listing business info provider. Then, the basic discount amount may be allowed to increase by an incremental amount (e.g. 1.5% additional discount to the basic discount) when a certain number of additional non-overlapped businesses (e.g. 20 additional businesses) are reached by a particular business info provider.

An advertisement discount (418) is for the purpose of rewarding business info providers to bring in revenue. In one embodiment of the invention, this discount can be based on a total number of posted advertisements (414), revenue from the total number of posted advertisements (414), a number of posted advertisements in a certain time period (e.g. number of advertisements in the last 4-week period (416)), and revenue from the posted advertisements in a certain time period. In one embodiment of the invention, the advertisement discount (418) is a fixed discount (e.g. 24% discount rate if more than 160 advertisements are posted in the past four weeks). In another embodiment, the advertisement discount (418) is a basic discount (e.g. 15% discount rate if the number of advertisements in the last four weeks exceeds 100) and an incremental additional discount rate (e.g. 1.5% for each 10 additional postings beyond 100 advertisements in the last four weeks). Some embodiments of the present invention may have a maximum ceiling to a discount rate (e.g. maximum ceiling discount rate of 30%).

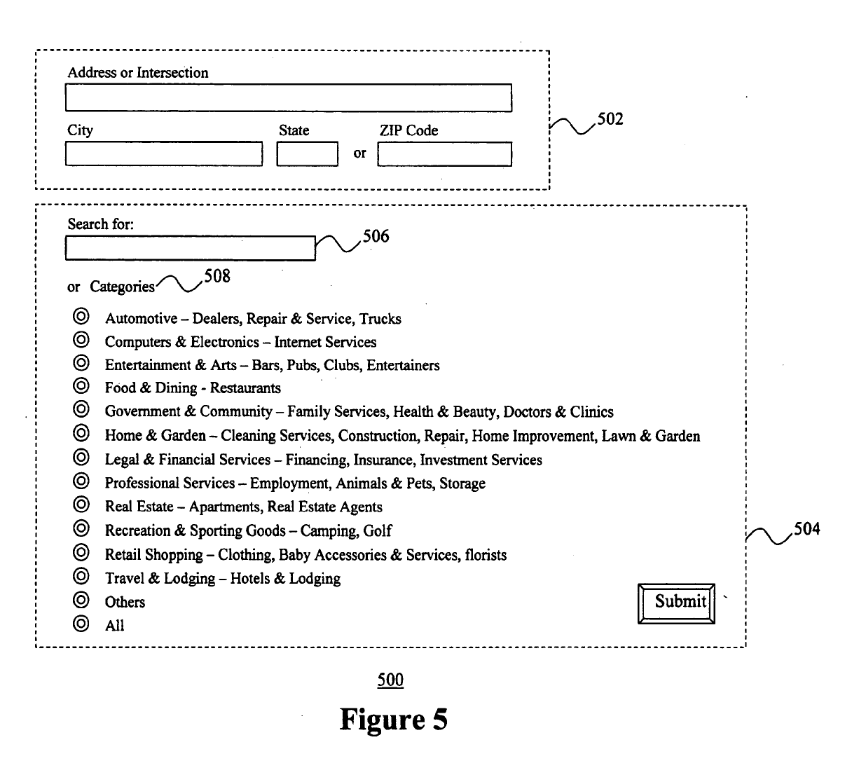

FIG. 5 shows a screenshot of a software interface (500) for conducting a geographic search (502) and a thematic search (504) by a user (116 or 118) accessing an online local search system (102) of FIG. 1 in accordance with an embodiment of the invention. In one embodiment of the invention, the online local search system (102) may integrate some local search results from a global search engine (e.g. Google AJAX search API and/or Yahoo REST API) to comprehensively cover all the geographic regions. In one embodiment of the invention, the online local search system (102) will display local search results from the global search engine for a geographic region with no registered business info providers and these results also provide a baseline to post business listings for any newly registered business info provider in this region. In another embodiment of the invention, the online local search system (102) displays the business listings from the registered business info providers first followed by the business listings from the global search engine for a partially-covered region. Yet in another embodiment of the invention, the online local search system (102) only displays the business listings from the registered business info providers for a well-covered region. In this case, it is likely that the global search engine also links to the business listings from the registered business info providers by crawling to the online local search system (102) (e.g. links from Google Maps to storefront pictures provided by infoUSA.) This type of affiliation also attracts additional Internet traffic to the online local search system (102).

In one embodiment of the invention, the thematic search (504) can be a query string typed in by the user (506). In another embodiment, the thematic search (504) can be a selection of categories (508). The category approach is also more suitable for the handheld device with limited viewing space. In one embodiment of the invention, the geographic search (502) is conducted by providing the ZIP code or the city and state. In another embodiment, the geographic search (502) can be refined by providing an address or a street intersection. Yet in another embodiment, the geographic search (502) can be replaced by a GPS coordinate provided by a handheld device.

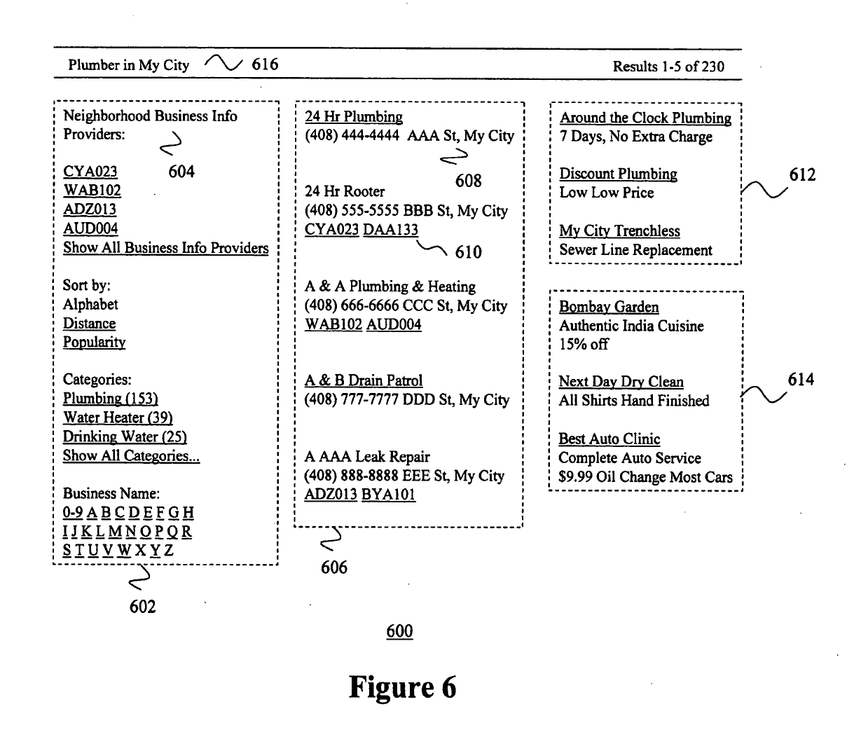

FIG. 6 shows a screenshot (600) of searching results from an online local search system (102) in accordance with an embodiment of the invention. This embodiment contains search results (606), sifting/sorting criteria (602), in-category advertisements (612), and out-category advertisements (614). In one embodiment of the invention, a first type of search result (608) contains a telephone number, an address, and a business name, wherein the business name links to a detailed business information as illustrated in FIG. 2. In another embodiment, a second type of search result (610) contains multiple links to each detailed business information provided by different business info providers. In this embodiment, the order of business info providers linked to the detailed business information may depend on the popularity of browsing statistics for the detailed business information provided by multiple business info providers. In one embodiment of the invention, the search results (606) can be sorted by alphabetic order, distance, or popularity of browsing statistics. In another embodiment, the search results (606) can be sifted by the categories or the leading characters of the business name. Yet in another embodiment, the search results (608) can be sifted by independent local business info providers (604) who contribute to the local business listings. When a business info provider is selected in this embodiment, only the first type of search result (608), the in-category advertisements (612), and the out-category advertisements (614) provided by the selected business info provider may be shown. In one embodiment of the invention, the order of displaying the business info provider list in (604) depends on a frequency of contributions by each business info provider, wherein the frequency is calculated by the business info provider's posted information (404).

In one embodiment of the invention, the in-category advertisements (612) are listed by randomly selecting advertisements from a weighted pool related to a search topic (616) from all neighborhood business info providers (604), wherein a weighting factor of a particular advertisement is determined by its purchased advertisement frequency (312) from FIG. 3. The out-category advertisements (614) are primarily for branding objectives as defined by advertisers. In one embodiment of the invention, the out-category advertisements (614) are listed by randomly selecting advertisements from a weighted pool from all neighborhood business info providers (604), wherein a weighting factor of a particular advertisement is determined by its purchased advertisement frequency (312) from FIG. 3.

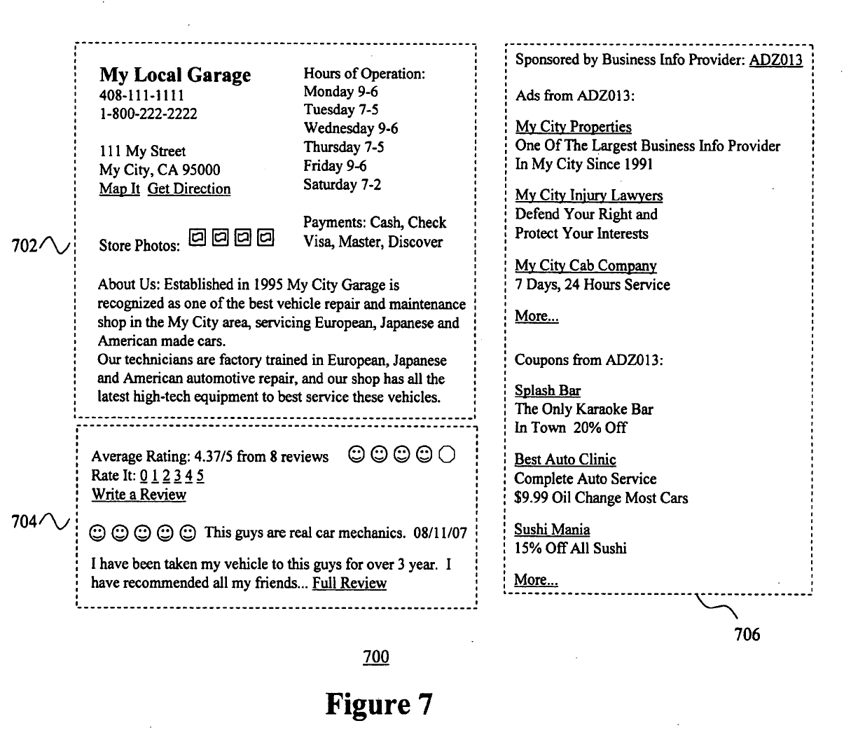

FIG. 7 shows a screenshot (700) of requested information by a user (116 or 118) for a particular business from an online local search system (102) of FIG. 1 in accordance with an embodiment of the invention. This embodiment contains detailed business information (702), a user review (704), and advertisements and coupons from a posted business info provider (706). In one embodiment of the invention, the detailed business information (702) is provided by a business info provider through an interface illustrated in FIG. 2. In one embodiment of the invention, only a registered user in the membership information database (110) can write a user review (704). In one embodiment of the invention, the advertisements and coupons from the posted business info provider (706) are listed by randomly selecting advertisements and coupons from a weighted pool of posted business info providers, wherein a weighting factor for displaying a particular advertisement or coupon is determined by its purchased advertisement frequency (312) as illustrated in FIG. 3. Because this screenshot (700) of requested information by the user (116 or 118) only displays the advertisements and coupons from the posted business info provider (706), it generally encourages business info providers to post more business information which gets linked to their related advertisements and coupons.

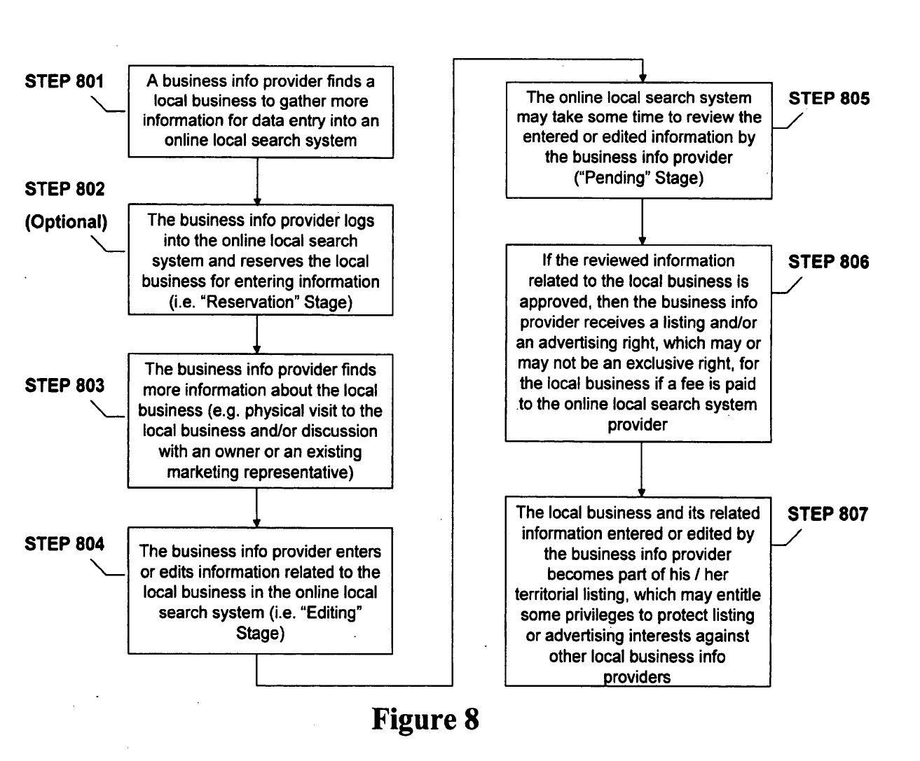

FIG. 8 shows a flowchart for using an online local search system for business info provider-based listing for local businesses based on a territorial listing concept in accordance with an embodiment of the invention. First, a business info provider finds a local business to gather more information for data entry into an online local search system (STEP 801). In one example, the local business may have been directly or indirectly discovered by the business info provider without searching the online local search system. In another example, the local business may have been listed in the online local search system with only bare-bone information (e.g. physical location of the local business) and the business info provider decides to find more information about that particular local business. Yet in another example, the business info provider may be an owner or an employee of the local business for listing or advertisement in the online local search system.

In an optional step called a “Reservation Stage”, the business info provider may “reserve” his/her intention to provide information for the particular business (STEP 802). This is called the territorial listing concept as explained previously. In one embodiment of the invention, if the business info provider reserves the particular business, other business info providers do not have a priority right to list information related to the reserved business entity for a certain number of days. For instance, if a second business info provider submits business information related to the particular business reserved by a first business info provider, the business information submitted by the second business info provider can be considered “overlapping” information, which may disqualify the second business info provider from privileges or rewards related to the reserved business entity. One example of reservation-based business information entry reward is higher exposure to in-category and/or out-category advertising pay-per-user-interest (e.g. pay-per-click, pay-per-impression, pay-per-action, and etc.) profit to a business info provider with a low number of overlapping information.

Continuing with FIG. 8, the business info provider finds more information about the local business as a next step (STEP 803). For instance, he/she may visit the local business, take pictures of exterior and/or interior of the local business, and talk to an owner of the local business to extract more information. In another instance, the business info provider may talk to a marketing representative (e.g. a Yellow Pages marketing representative) who agreed to represent some marketing functions of the local business. Then, the business info provider enters or edits information related to the local business in the online local search system operatively connected to a software interface (STEP 804). This step is called an “Editing Stage”.

Once the business info provider submits information related to the local business, the online local search system may take some time to review the entered or edited information by the business info provider (STEP 805). This step is called a “Pending Stage”. Then, if the reviewed information related to the local business is approved, the business info provider receives a listing and/or and advertising right which may or may not be an exclusive right relative to other business info providers (STEP 806). In one embodiment of the invention, the online local search system charges a listing fee and/or an advertising-hosting fee to the business info provider to list and/or advertise the local business. In another embodiment of the invention, the online local search system provides listing and/or advertising-hosting services free of charge under certain circumstances (e.g. typically as an introductory incentive) to promote robust utilization of the online local search system to the business info provider.

Continuing with FIG. 8, once the online local search system approves the submitted information related to the local business and the business info provider decides to list and/or advertise the local business in the online local search system (i.e. by submitting certain listing and/or advertising-hosting fees if required), the local business with newly-approved information becomes part of the business info provider's territorial listing (STEP 807). In one embodiment of the invention, a territorial listing entitles some privileges and/or rewards to protect listing or advertising interests against other local business info providers. In one embodiment of the invention, a business info provider who has a large territorial listing may have pay-per-user-interest (e.g. pay-per-click, pay-per-impression, pay-per-action, and etc.) profit advantages for in-category or out-category advertisements, as explained previously.

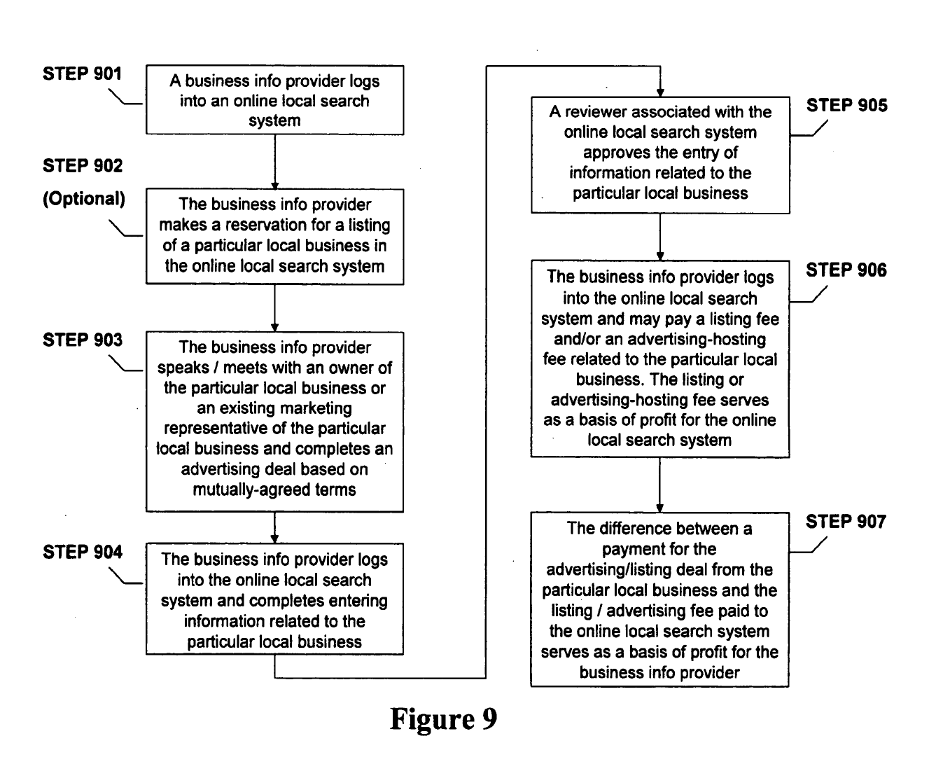

FIG. 9 shows a flowchart for a first method of conducting business between a business info provider and an online local search system in accordance with an embodiment of the invention. The first method of conducting business shows a first profit relationship between the online local search system and the business info provider. First, a business info provider logs into an online local search system (STEP 901). Then, as an optional step, the business info provider makes a reservation for a listing of a particular local business in the online local search system (STEP 902). The business info provider then speaks and/or meets with an owner of the particular local business or an existing marketing representative related to the particular local business (e.g. a Yellow Pages marketing representative) and negotiates an advertising/listing deal based on mutually-agreed terms (STEP 903).

Continuing with FIG. 9, the business info provider then logs into the online local search system and completes entering information related to the particular local business (STEP 904). Then, in a preferred embodiment of the invention, a reviewer associated with the online local search system approves the entry of information related to the particular local business (STEP 905). Once the entry of information related to the particular local business is approved, the business info provider logs into the online local search system and may pay a listing fee and/or an advertising-hosting fee related to the particular local business (STEP 906). The listing or advertising-hosting fee serves as a basis of profit for the online local search system. In one embodiment of the invention, the business info provider then derives a source of profit by keeping the difference between a payment for the advertising/listing deal from the particular local business and the listing/advertising-hosting fee paid to the online local search system, if any (STEP 907).

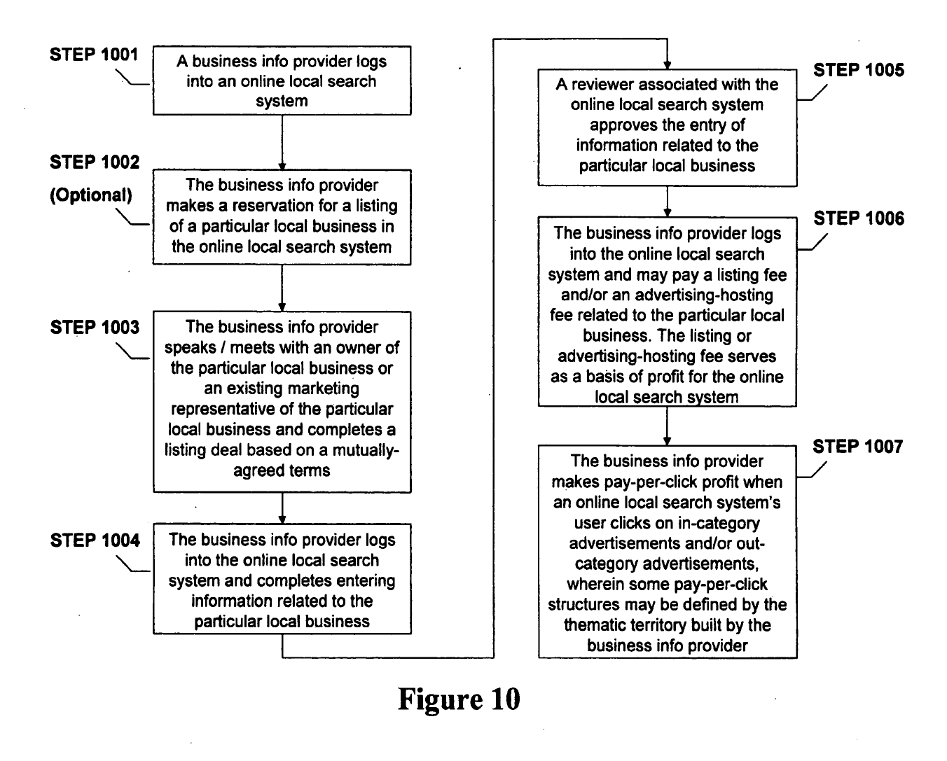

FIG. 10 shows a flowchart for a second method of conducting business between a business info provider and an online local search system in accordance with an embodiment of the invention. The second method of conducting business shows a second profit relationship between the online local search system and the business info provider. First, a business info provider logs into an online local search system (STEP 1001). Then, as an optional step, the business info provider makes a reservation for a listing of a particular local business in the online local search system (STEP 1002). The business info provider then speaks and/or meets with an owner of the particular local business or an existing marketing representative related to the particular local business (e.g. a Yellow Pages marketing representative) and completes a listing deal based on mutually-agreed terms (STEP 1003). In one embodiment of the invention, the local owner himself/herself takes the role of the business info provider.

Continuing with FIG. 10, the business info provider then logs into the online local search system and completes entering information related to the particular local business (STEP 1004). Then, in a preferred embodiment of the invention, a reviewer associated with the online local search system approves the entry of information related to the particular local business (STEP 1005). Once the entry of information related to the particular local business is approved, the business info provider logs into the online local search system and may pay a listing fee and/or an advertising-hosting fee related to the particular local business (STEP 1006). The listing or advertising-hosting fee serves as a basis of profit for the online local search system. In one embodiment of the invention, the business info provider then makes a pay-per-user-interest (e.g. pay-per-click, pay-per-impression, pay-per-action, and etc.) profit when the online local search system's user clicks on an in-category advertisement and/or an out-category advertisement (STEP 1007), wherein some pay-per-user-interest (e.g. pay-per-click, pay-per-impression, pay-per-action, and etc.) profit structures correspond to a thematic business listing territory constructed by the business info provider.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus for an online local search system communicating with online local search system users and business info providers, the apparatus comprising:
the online local search system configured to provide one or more databases for local business listing information, advertisement information, and membership information, wherein the one or more databases are accessible by the online local search system users and the business info providers over a web interface;
a first software interface configured to reserve a plurality of business listings by the business info providers, wherein the first software interface is configured to reserve one or more business listings for a particular business info provider to grant an exclusive or non-exclusive right for data field entry for a certain number of days reserved by the online local search system; and
a second software interface configured to process a business listing fee and/or an advertising-hosting fee submitted by the particular business info provider to the online local search system after the data field entry is complete for the one or more business listings reserved by the particular business info provider, wherein the business listing fee and/or the advertising-hosting fee are configured to be adjusted by discount incentive variables, including a total number of listings and/or a total number of advertisements posted to the online local search system by the particular business info provider.

2. The apparatus of claim 1, further comprising a third software interface configured to receive the data field entry related to the one or more business listings, wherein the data field entry comprises a business name, a business phone number, and a short description of business overview.

3. The apparatus of claim 1, further comprising a fourth software interface configured to allow the online local search system users to access the local business listing information, the advertisement information, and/or the membership information using a geographic search method or a thematic search method.

4. The apparatus of claim 1, further comprising an HTTP server configured to host the web interface.

5. The apparatus of claim 1, wherein the exclusive or non-exclusive right for the data field entry reduces unwanted duplicated information entries for the one or more business listings.

6. The apparatus of claim 1, wherein the data field entry by the particular business info provider is subject to an approval process by a content reviewer associated with the online local search system.

7. The apparatus of claim 1, wherein the online local search system comprises a distributed system with one or more computer servers and databases to contain a variety of information, including the local business listing information, the advertisement information, and/or the membership information

8. The apparatus of claim 2, wherein the data field entry related to the one or more business listings further comprises a GPS coordinate.

9. The apparatus of claim 3, wherein the fourth software interface displays a plurality of advertisements prioritized at least in part by an advertising frequency setting for a particular advertisement.

10. The apparatus of claim 9, wherein the plurality of advertisements are divided into in-category advertisements and out-category advertisements.

11. A method for using an online local search system for business info provider-based listing for local businesses based on a territorial listing concept, the method comprising:
finding a local business to gather information for data entry into the online local search system;
finding more information about the local business by visiting the local business or having a discussion with an owner of the local business or a marketing representative associated with the local business;
submitting the information for data entry related to the local business into the online local search system;
waiting for a reviewer associated with the online local search system to complete an approval process for the data entry related to the local business; and
receiving a listing fee discount and/or an advertisement-hosting fee discount from the online local search system if the data entry is approved by the reviewer and a certain criteria is met for fee discount.

12. The method of claim 11, further comprising the step of logging into the online local search system to reserve the local business for entering information, wherein the step of reserving the local business for entering information grants a particular business info provider an exclusive right to enter or edit the data entry related to the local business against other business info providers for a certain number of days.

13. The method of claim 11, further comprising a step of listing the data entry related to the local business in the online local search system after the approval process, wherein the step of listing the date entry expands an in-category advertising territory and/or an out-category advertising territory of a business info provider who made the data entry related to the local business.

14. The method of claim 11, wherein the certain criteria includes a total number of business listings and a total number of overlapped business listings by a business info provider.

15. A method for conducting business between a business info provider and an online local search system, the method comprising:
logging into an online local search system as the business info provider;
optionally making a reservation for potentially entering or updating information related to a particular local business in the online local search system for a certain number of days;
speaking and/or meeting with an owner of the particular local business or a marketing representative associated with the particular local business and completing a listing deal and/or an advertising deal based on mutually-agreed terms;
logging into the online local search system and completing information entry related to the particular local business which may have been optionally reserved by the business info provider;
waiting for an approval of the information entry from the online local search system; and
logging into the online local search system after the approval to pay a listing fee and/or an advertising-hosting fee related to the particular local business.

16. The method of claim 15, further comprising a step of keeping at least a portion of a difference between a payment for the listing deal and/or the advertising deal and the listing fee and/or the advertising-hosting fee paid to the online local search system, wherein the difference serves as a basis for the business info provider's profit.

17. The method of claim 15, further comprising a step of making a pay-per-user-interest (e.g. pay-per-click, pay-per-impression, pay-per-action, and etc.) profit by the business info provider when an online local search system's user clicks on an in-category advertisement or an out-category advertisement, wherein the in-category advertisement is at least partly prioritized by a size of the business info provider's in-category advertisement territory.

18. The method of claim 15, wherein the listing fee and/or the advertising-hosting fee related to the particular local business is free of charge to the business info provider during a promotional period defined by the online local search system.
